(19) United States
(12) Patent Application Publication
(10) Pub. No.: US 2009/0055917 A1
(43) Pub. Date: Feb. 26, 2009

(54) Authentication method and authentication system using the same

(76) Inventor: Kazunori Miyazawa, Musashino-shi (JP)

Correspondence Address: EDWARDS ANGELL PALMER & DODGE LLP, P.O. BOX 55874, BOSTON, MA, 02205, US

(21) Appl. No.: 11/991,099

(22) PCT Filed: May 17, 2007
(86) PCT No.: PCT/JP2007/060163

§ 371 Date: Feb. 27, 2008

(30) Foreign Application Priority Data
May 18, 2006 (JP) 2006-138578

(51) Int. Cl. G06F 21/20; H04L 9/32

(52) U.S. Cl. 726/10

(57) ABSTRACT

An authentication method is provided in which authentication is performed between terminals respectively belonging to a first realm and a second realm that is different from the first realm, with using a Kerberos authentication method. In order to obtain authentication with a terminal belonging to the second realm, a terminal belonging to the first realm requests a ticket granting ticket for accessing a key distribution center in the second realm, from a key distribution center in the first realm. The key distribution center in the first realm transmits an encrypted IP address of the key distribution center in the second realm together with the requested ticket granting ticket, to the terminal belonging to the first realm.

### TECHNICAL FIELD

The present invention relates to an authentication method which is used on the network, and also to an authentication system which uses this, and particularly to an authentication method in which mutual authentication that is high in security is enabled between different realms (units of administration authority of authentication) without previously setting an IP (Internet Protocol) address of a Key Distribution Center (hereinafter, referred to as KDC), to a terminal, and also to an authentication system which uses this.

### BACKGROUND ART

As an authentication method of performing authentication on a general network such as the Internet, there is Kerberos authentication (an authentication method which was developed by Project Athena in Massachusetts Institute of Technology, and which is used on a network). As technical references relating to Kerberos authentication, there are the following references.

Patent Reference 1: Japanese Patent Unexamined Publication No. 2003-099401

Patent Reference 2: Japanese Patent Unexamined Publication No. 2004-178361

Patent Reference 3: Japanese Patent Unexamined Publication No. 2005-018748

A KDC in Kerberos authentication is configured by one or more computers. In a KDC, usually, functions of an Authentication Server (hereinafter, referred to as AS) and a Ticket Granting Server (hereinafter, referred to as TGS) operate.

In response to a request from a terminal, the AS issues a Ticket Granting Ticket (a certificate for certifying the terminal itself, hereinafter, referred to as TGT). The TGS issues a service ticket for using a service provided by a server or the like.

FIG. 6 is a configuration block diagram showing an example of an authentication system which uses an authentication method of such a related art. In FIG. 6, the reference numeral 1 denotes a terminal which is to perform mutual authentication with other terminals, the reference numerals 2 and 5 denote terminals which are objects of mutual authentication of the terminal 1, the reference numerals 3 and 4 denote KDCs, and the reference numeral 6 denotes a DNS (Domain Name System) server which provides IP addresses of the KDCs.

The terminal 1, the terminal 2, and the KDC 3 are included in a realm 100, and the KDC 4 and the terminal 5 are included in a realm 101. The terminal 1 is mutually connected to the terminal 2, the KDC 3, the KDC 4, the terminal 5, and the DNS server 6 via a network or the like.

Hereinafter, the operation of the example of the related art shown in FIG. 6 will be described with reference to FIGS. 7 and 8. FIG. 7 is a message flowchart illustrating an operation in the case where an authentication service in the same realm is provided, and FIG. 8 is a message flowchart illustrating an operation in the case where an authentication service between different realms is provided.

The procedure of an authentication process in the case where the terminal 1 receives a service provided by the terminal 2 will be described with reference to FIG. 7.

Actually, data transmission/reception between a terminal and a KDC or a terminal and a terminal is performed by a message in accordance with the Kerberos protocol, and also a TGT and a service ticket are transmitted/received with being included in the message. For the sake of simplicity of description, however, this will be omitted in the subsequent description.

In “S001” in FIG. 7, the terminal 1 requests a TGT A from an AS of the KDC 3. In “S002” in FIG. 7, in response to the TGT request, the AS of the KDC 3 encrypts the TGT A including a session key (hereinafter, referred to as “session key A”) which is used in a communication between the terminal 1 and a TGS of the KDC 3, with a secret key (hereinafter, referred to as “secret key A”) of the TGS of the KDC 3 (hereinafter, such a TGT A is referred to as “encrypted TGT A”), further encrypts “session key A” with a secret key (hereinafter, referred to as “secret key B”) of the terminal 1, and transmits the encrypted key together with “encrypted TGT A” to the terminal 1.

The terminal 1 receives “encrypted TGT A” and encrypted “session key A”, and decrypts encrypted “session key A” with “secret key B” to obtain “session key A”. If the terminal which receives encrypted “session key A” is not the terminal 1, the terminal does not have “secret key B”, and hence the key cannot be decrypted, so that “session key A” cannot be obtained.

At the timing when the terminal 1 obtains “session key A”, therefore, the process of “authentication of the terminal 1” by the AS of the KDC 3 is completed.

In “S003” in FIG. 7, the terminal 1 transmits an authenticator encrypted with “session key A”, “encrypted TGT A”, and an identifier such as the name of the terminal 2, to the TGS of the KDC 3, and requests a service ticket A (a certificate for certifying that the terminal 1 is authenticated by the KDC 3). The authenticator produced by the terminal 1 is configured by the name of the terminal 1, the IP address, the present time, etc.

The TGS of the KDC 3 receives the authenticator encrypted with “session key A”, “encrypted TGT A”, and the identifier such as the name of the terminal 2, and decrypts “encrypted TGT A” with “secret key A”. From the decrypted TGT A, “session key A” is obtained, and the authenticator of the terminal 1 encrypted with “session key A” is decrypted.

The TGS of the KDC 3 compares the decrypted TGT A with the authenticator of the terminal 1, and checks that the terminal certified by the TGT A is the terminal 1. In “S004” in FIG. 7, in response to a request for a service ticket, the TGS of the KDC 3 encrypts the service ticket A including a session key (hereinafter, referred to as “session key B”) which is used in a communication between the terminal 1 and the terminal 2, with a secret key (hereinafter, referred to as “secret key C”) of the terminal 2 (hereinafter, such a service ticket is referred to as “encrypted service ticket A”), further encrypts “session key B” with “session key A”, and transmits the encrypted key together with “encrypted service ticket A” to the terminal 1.

The terminal 1 receives “encrypted service ticket A” and encrypted “session key B”, and decrypts encrypted “session key B” with “session key A” to obtain “session key B”. If the terminal which receives encrypted “session key B” is not the terminal 1, the terminal does not have “session key A”, and hence the key cannot be decrypted, so that “session key B” cannot be obtained.

At the timing when the terminal 1 obtains “session key B”, therefore, the process of “authentication of the terminal 1” by the TGS of the KDC 3 is completed.

In “S005” in FIG. 7, the terminal 1 transmits an authenticator encrypted with “session key B”, and “encrypted service ticket A” to the terminal 2, and requests a service provided by the terminal 2.

In “S006” in FIG. 7, finally, the terminal 2 decrypts “encrypted service ticket A” with “secret key C”, obtains “session key B”, and decrypts the encrypted authenticator of the terminal 1. The terminal 2 compares the decrypted service ticket A with the authenticator of the terminal 1, and checks that the terminal certified by the service ticket A is the terminal 1.

Next, the procedure of an authentication process in the case where the terminal 1 receives a service provided by the terminal 5 in the different realm will be described with reference to FIG. 8. In “S101” in FIG. 8, the terminal 1 requests the TGT A from the AS of the KDC 3. In “S102” in FIG. 8, in response to the TGT request, the AS of the KDC 3 encrypts the TGT A including “session key A” with “secret key A”, further encrypts “session key A” with “secret key B”, and transmits the encrypted key together with “encrypted TGT A” to the terminal 1.

The terminal 1 receives “encrypted TGT A” and encrypted “session key A”, and decrypts encrypted “session key A” with “secret key B” to obtain “session key A”. If the terminal which receives encrypted “session key A” is not the terminal 1, the terminal does not have “secret key B”, and hence the key cannot be decrypted, so that “session key A” cannot be obtained.

At the timing when the terminal 1 obtains “session key A”, therefore, the process of “authentication of the terminal 1” by the AS of the KDC 3 is completed.

In “S103” in FIG. 8, the terminal 1 transmits an authenticator encrypted with “session key A”, “encrypted TGT A”, and an identifier such as the name of the KDC 4, to the TGS of the KDC 3, and requests a TGT for accessing the KDC 4.

The TGS of the KDC 3 receives the authenticator encrypted with “session key A”, “encrypted TGT A”, and the identifier such as the name of the KDC 4, and decrypts “encrypted TGT A” with “secret key A”. From the decrypted TGT A, “session key A” is obtained, and the authenticator of the terminal 1 encrypted with “session key A” is decrypted.

The TGS of the KDC 3 compares the decrypted TGT A with the authenticator of the terminal 1, and checks that the terminal certified by the TGT A is the terminal 1. In “S104” in FIG. 8, in response to the TGT request for accessing the KDC 4, the TGS of the KDC 3 encrypts a TGT B including a session key (hereinafter, referred to as “session key C”) which is used in a communication between the terminal 1 and the KDC 4, with a secret key (hereinafter, referred to as “secret key D”) of the KDC 4 (hereinafter, such a TGT is referred to as “encrypted TGT B”), further encrypts “session key C” with “session key A”, and transmits the encrypted key together with “encrypted TGT B” to the terminal 1.

The terminal 1 receives “encrypted TGT B” and encrypted “session key C”, and decrypts encrypted “session key C” with “session key A” to obtain “session key C”. If the terminal which receives encrypted “session key C” is not the terminal 1, the terminal does not have “session key A”, and hence the key cannot be decrypted, so that “session key C” cannot be obtained.

At the timing when the terminal 1 obtains “session key C”, therefore, the process of “authentication of the terminal 1” by the TGS of the KDC 3 is completed.

In “S105” in FIG. 8, the terminal 1 transmits an authenticator encrypted with “session key C”, “encrypted TGT B”, and an identifier such as the name of the terminal 5 to the TGS of the KDC 4, and requests a service ticket B (a certificate for certifying that the terminal 1 is authenticated by the KDC 4).

The TGS of the KDC 4 receives the authenticator encrypted with “session key C”, “encrypted TGT B”, and the identifier such as the name of the terminal 2, and decrypts “encrypted TGT B” with “secret key C”. From the decrypted TGT B, “session key C” is obtained, and the authenticator of the terminal 1 encrypted with “session key C” is decrypted.

The TGS of the KDC 4 compares the decrypted TGT B with the authenticator of the terminal 1, and checks that the terminal certified by the TGT B is the terminal 1. In “S106” in FIG. 8, in response to the request for the service ticket B, the TGS of the KDC 4 encrypts the service ticket B including a session key (hereinafter, referred to as “session key D”) which is used in a communication between the terminal 1 and the terminal 5, with a secret key (hereinafter, referred to as “secret key E”) of the terminal 5 (hereinafter, such a service ticket is referred to as “encrypted service ticket B”), further encrypts “session key D” with “session key C”, and transmits the encrypted key together with “encrypted service ticket B” to the terminal 1.

The terminal 1 receives “encrypted service ticket B” and encrypted “session key D”, and decrypts encrypted “session key D” with “session key C” to obtain “session key D”. If the terminal which receives encrypted “session key D” is not the terminal 1, the terminal does not have “session key C”, and hence the key cannot be decrypted, so that “session key D” cannot be obtained.

At the timing when the terminal 1 obtains “session key D”, therefore, the process of “authentication of the terminal 1” by the TGS of the KDC 4 is completed.

In “S107” in FIG. 8, the terminal 1 transmits an authenticator encrypted with “session key D”, and “encrypted service ticket B” to the terminal 5, and requests a service provided by the terminal 5.

In “S108” in FIG. 8, finally, the terminal 5 decrypts “encrypted service ticket B” with “secret key E”, obtains “session key D”, and decrypts the encrypted authenticator of the terminal 1. The terminal 5 compares the decrypted service ticket with the authenticator of the terminal 1, and checks that the terminal certified by the service ticket B is the terminal 1.

In the case where an authentication service between different realms is to be provided, the IP address of the KDC 4 is previously set in the terminal 1, or the terminal 1 obtains the IP addresses of the KDC 4 from the DNS server 6 as shown in FIG. 6.

As a result, the terminal 1 obtains the TGT B for accessing the KDC 4 in the realm 101, from the AS of the KDC 3, the service ticket B to the terminal 5 is obtained with using the TGT B from the TGS of the KDC 4, and authentication is requested with using the service ticket B to the terminal B, thereby allowing the terminal 1 belonging to the realm 100 to be authenticated by the terminal 5 belonging to the realm 101. Therefore, mutual authentication is enabled between different realms.

### DISCLOSURE OF THE INVENTION

### Problems that the Invention is to Solve

In the related art example shown in FIG. 6, in order that the terminal 1 belonging to the realm 100 accesses the terminal 5 belonging to the realm 101, the terminal must communicate with the KDC 4 in the realm 101. In this case, the IP addresses of the KDC 4 must be previously set in the terminal 1, or the terminal 1 must obtain the IP address of the KDC 4 from the DNS server 6.

In the case where the IP address of the KDC 4 is previously set, there are problems in that, when the number of terminals is increased, the manhour required for the setting is enormous, and that resetting is necessary each time when the IP address of the KDC 4 is changed.

In the case where the IP address of the KDC 4 is obtained from the DNS server 6, it is not necessary to previously set the IP address of the KDC 4, but there is a problem in that the security is low.

Therefore, the problem to be solved by the invention is to realize an authentication method in which mutual authentication that is high in security is enabled between different realms without previously setting an IP address of a KDC, to a terminal, and also an authentication system which uses this.

### Means for Solving the Problem

In order to attain the object, the authentication method of the invention is

an authentication method in which authentication is performed between terminals respectively belonging to a first realm and a second realm that is different from the first realm, with using a Kerberos authentication method, wherein

in order to obtain authentication with a terminal belonging to the second realm, a terminal belonging to the first realm requests a ticket granting ticket for accessing a key distribution center in the second realm, from a key distribution center in the first realm,

the key distribution center in the first realm transmits an encrypted IP address of the key distribution center in the second realm together with the requested ticket granting ticket, to the terminal belonging to the first realm,

based on the IP address, the terminal belonging to the first realm accesses the key distribution center in the second realm, to receive provision of a service ticket, and

the terminal belonging to the second realm authenticates the terminal belonging to the first realm with using the service ticket.

Therefore, mutual authentication that is high in security is enabled between different realms without previously setting an IP address of a key distribution center to a terminal.

The authentication system of the invention is an authentication system in which authentication is performed between terminals respectively belonging to a first realm and a second realm that is different from the first realm, with using a Kerberos authentication method, wherein the system comprises:

a terminal which belongs to the first realm, and which, in order to obtain authentication with a terminal belonging to the second realm, requests a ticket granting ticket for accessing a key distribution center in the second realm;

a key distribution center which is in the first realm, and which transmits an encrypted IP address of the key distribution center in the second realm together with the requested ticket granting ticket, to the terminal belonging to the first realm;

the key distribution center which is in the second realm, and which provides a service ticket based on the ticket granting ticket obtained by the terminal belonging to the first realm; and

a terminal which belongs to the second realm, and which authenticates the terminal belonging to the first realm with using the service ticket.

Therefore, mutual authentication that is high in security is enabled between different realms without previously setting an IP address of a key distribution center to a terminal.

The authentication system of the invention is

an authentication system in which authentication is performed between terminals respectively belonging to different realms, with using a Kerberos authentication method, wherein the system comprises:

a terminal which belongs to a first realm, and which, in order to obtain authentication with an arbitrary one of plural terminals respectively belonging to plural different realms, requests a ticket granting ticket for accessing a key distribution center in a second realm to which the arbitrary terminal belongs;

a key distribution center which is in the first realm, which selects an IP address of the key distribution center in the second realm to which the arbitrary terminal belongs, from IP addresses of plural key distribution centers respectively in the plural different realms, and which transmits the selected encrypted IP address of the key distribution center in the second realm together with the requested ticket granting ticket, to the terminal belonging to the first realm;

the key distribution center which is in the second realm, and which provides a service ticket based on the ticket granting ticket obtained by the terminal belonging to the first realm; and

the arbitrary terminal which authenticates the terminal belonging to the first realm with using the service ticket.

Therefore, mutual authentication that is high in security is enabled between different realms without previously setting an IP address of a key distribution center to a terminal.

The authentication system of the invention is

an authentication system in which authentication is performed between terminals respectively belonging to different realms, with using a Kerberos authentication method, wherein the system comprises:

a first terminal which belongs to a first realm, and which, in order to obtain authentication with a second terminal belonging to a third realm, requests a ticket granting ticket for accessing a key distribution center in the third realm, from a first key distribution center in the first realm or a second key distribution center in a second realm;

the first key distribution center which transmits an encrypted IP address of the second key distribution center together with the requested ticket granting ticket, to the first terminal;

the second key distribution center which transmits an encrypted IP address of the third key distribution center together with the requested ticket granting ticket, to the first terminal;

the third key distribution center which provides a service ticket based on the ticket granting ticket that is obtained by the first terminal from the second key distribution center; and

the second terminal which authenticates the first terminal with using the service ticket.

Therefore, mutual authentication that is high in security is enabled between different realms without previously setting an IP address of a key distribution center to a terminal.

### Effects of the Invention

According to the authentication method and the authentication system of the invention, an encrypted IP address of a key distribution center in a different realm together with a ticket granting ticket, to a terminal, whereby mutual authentication that is high in security is enabled between different realms without previously setting the IP address of the key distribution center to a terminal.

### BRIEF DESCRIPTION OF THE DRAWINGS

FIG. 1 is a configuration block diagram showing an embodiment of the authentication method of the invention and an authentication system which uses this.

FIG. 2 is a message flowchart illustrating an operation in the case where an authentication service between different realms is provided.

FIG. 3 is a configuration block diagram showing another embodiment of the authentication method of the invention and an authentication system which uses this.

FIG. 4 is a configuration block diagram showing another embodiment of the authentication method of the invention and an authentication system which uses this.

FIG. 5 is a message flowchart illustrating an operation in the case where an authentication service between different realms is provided.

FIG. 6 is a configuration block diagram showing an example of an authentication system which uses an authentication method of a related art.

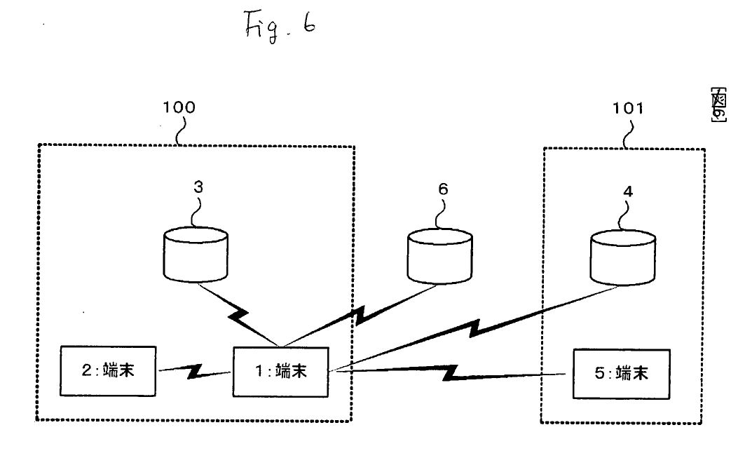

FIG. 7 is a message flowchart illustrating an operation in the case where an authentication service in the same realm is provided.

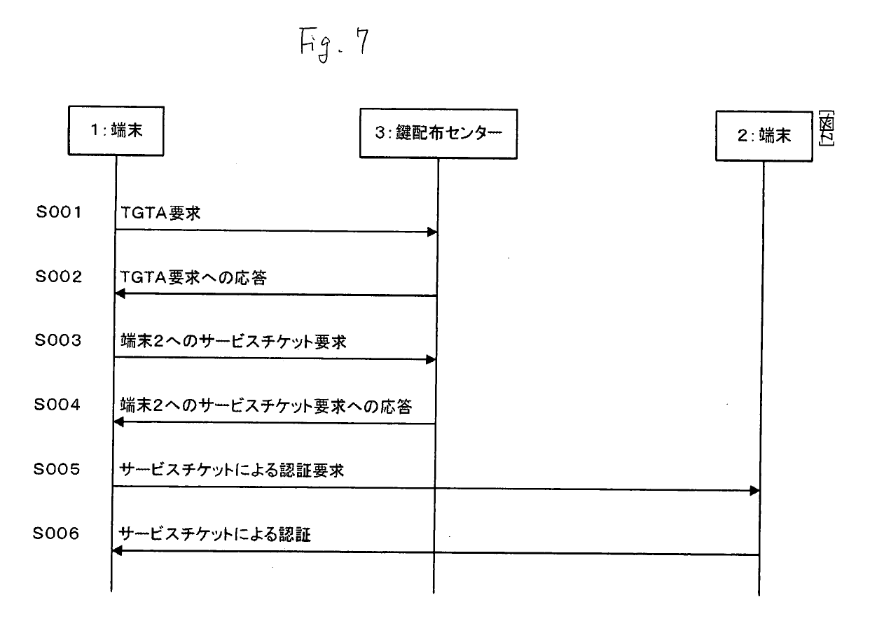

FIG. 8 is a message flowchart illustrating an operation in the case where an authentication service between different realms is provided.

### DESCRIPTION OF REFERENCE NUMERALS AND SIGNS

1, 2, 5, 7, 9, 11, 13, 15, 17, 20 terminal

3, 4, 8, 10, 12, 14, 16, 18, 19, 21 key distribution center

6 DNS server

100, 101, 102, 103, 104, 105, 106, 107, 108, 109 realm

### BEST MODE FOR CARRYING OUT THE INVENTION

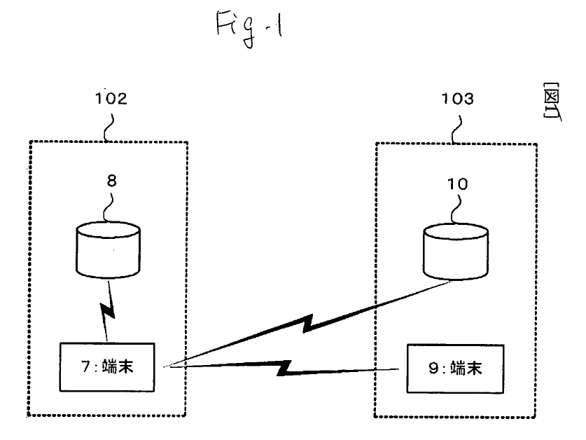

Hereinafter, the invention will be described in detail with reference to the drawings. FIG. 1 is a configuration block diagram showing an embodiment of the authentication method of the invention and an authentication system which uses this.

In FIG. 1, the reference numeral 7 denotes a terminal which is to perform mutual authentication with another terminal, the reference numerals 8 and 10 denote KDCs, and the reference numeral 9 denotes a terminal which is an object of mutual authentication of the terminal 7. The terminal 7 and the KDC 8 are included in a realm 102, and the terminal 9 and the KDC 10 are included in a realm 103. The terminal 7 is mutually connected to the KDC 8, the terminal 9, and the KDC 10 via a network or the like.

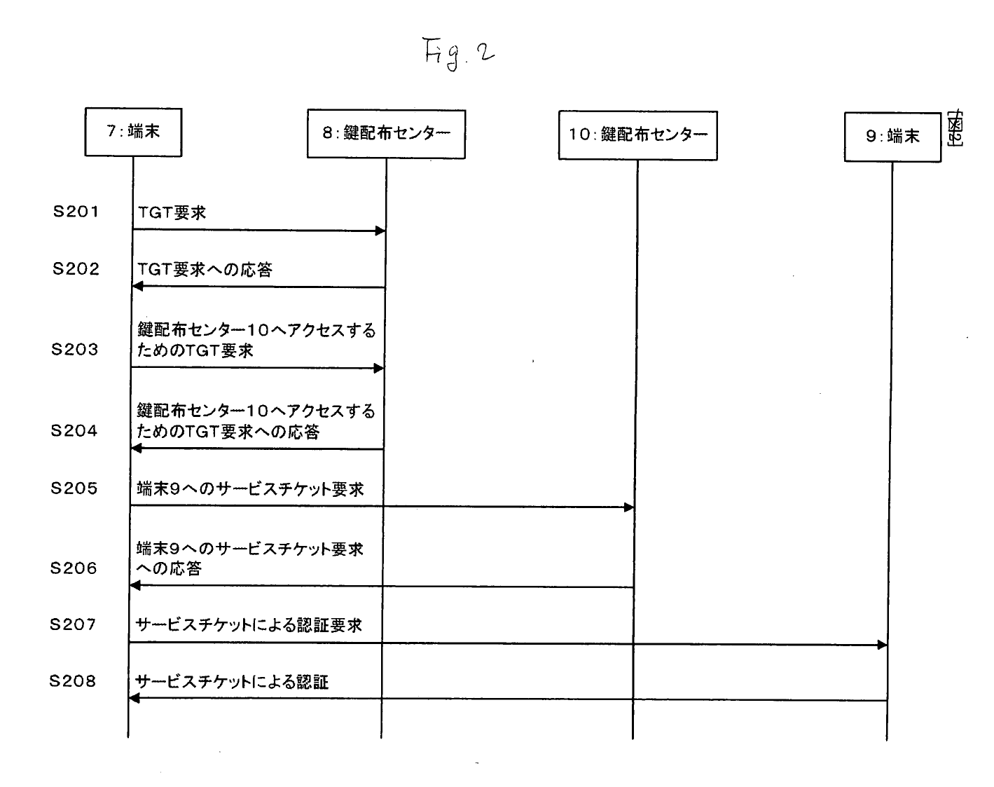

Hereinafter, the operation of the embodiment shown in FIG. 1 will be described with reference to FIG. 2. FIG. 2 is a message flowchart illustrating an operation in the case where an authentication service between different realms is provided.

In the operation of the embodiment shown in FIG. 1, an IP address of a KDC in a different realm is embedded in an encryption portion of a TGT reply message to a TGT request.

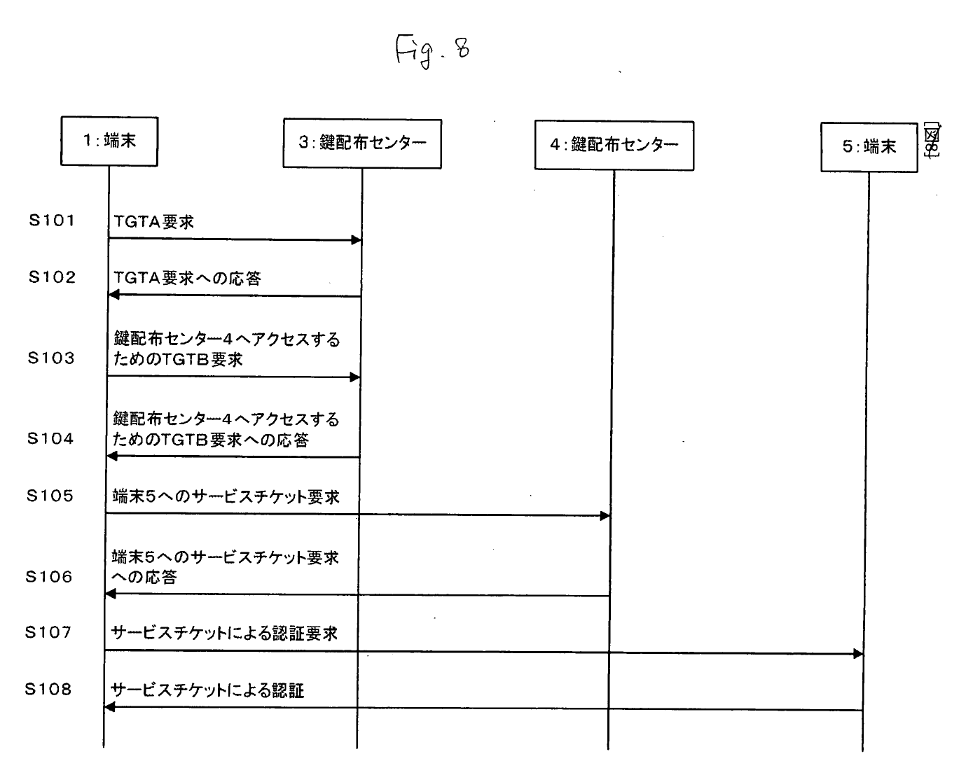

In the following description, the detailed description of encryption between a terminal and a KDC or a terminal and a terminal is identical with that of FIG. 8, and hence omitted.

The procedure of an authentication process in the case where the terminal 7 receives a service provided by the terminal 9 in the different realm will be described with reference to FIG. 2. In “S201” in FIG. 2, the terminal 7 requests a TGT from an AS of the KDC 8. In “S202” in FIG. 2, in response to the TGT request, the AS of the KDC 8 transmits a TGT reply message including a TGT to the terminal 7.

The terminal 7 previously recognizes that the terminal 9 is under administration of the KDC 10. In “S203” in FIG. 2, therefore, the terminal 7 requests a TGT for accessing the KDC 10 from a TGS of the KDC 8. In “S204” in FIG. 2, in response to the TGT request, the TGS of the KDC 8 transmits a TGT reply message in which the IP address of the KDC 10 is embedded in an encryption portion, to the terminal 7.

In “S205” in FIG. 2, then, the terminal 7 extracts and decrypts the encrypted IP address of the KDC 10 from the obtained TGT reply message, and transmits the TGT to the TGS of the KDC 10 to request a service ticket which is a certificate for certifying that the terminal 7 is authenticated by the KDC 10. In “S206” in FIG. 2, in response to the request for a service ticket, the TGS of the KDC 10 transmits the service ticket to the terminal 7.

In “S207” in FIG. 2, the terminal 7 transmits the service ticket obtained in “S206” in FIG. 2 to the terminal 9 to request authentication. In “S208” in FIG. 2, finally, the terminal 9 which checks the service ticket authenticates the terminal 7.

As a result, the terminal 7 obtains the TGT reply message in which the IP address of the KDC 10 is embedded in the encryption portion, from the TGS of the KDC 8, and extracts and decrypts the encrypted IP address of the KDC 10, whereby the terminal 7 is enabled to safely obtain the IP address of the KDC 10. Furthermore, a service ticket to the terminal 9 is obtained from the TGS of the KDC 10 with using the TGT, authentication is requested to the terminal 9 with using the service ticket, and the terminal 7 is authenticated by the terminal 9, whereby mutual authentication that is high in security is enabled between different realms without previously setting the IP address of the KDC 10 to the terminal 7.

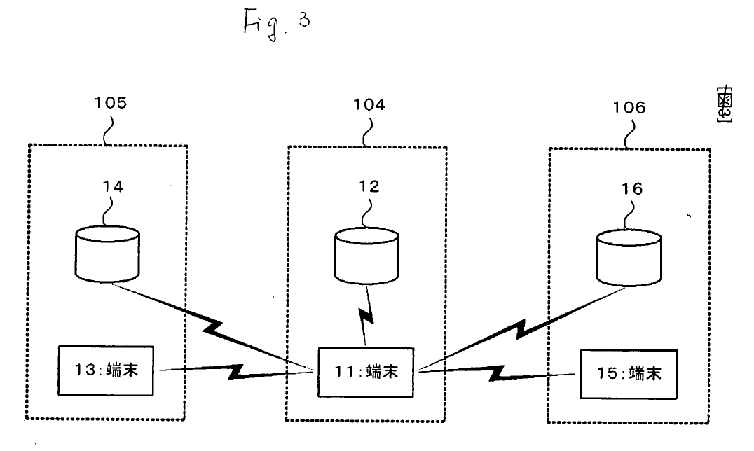

FIG. 3 is a configuration block diagram showing another embodiment of the authentication method of the invention and an authentication system which uses this.

In FIG. 3, the reference numeral 11 denotes a terminal which is to perform mutual authentication with another terminal, the reference numerals 12, 14, and 16 denote KDCs, and the reference numerals 13 and 15 denote terminals which are objects of the mutual authentication of the terminal 11. The terminal 11 and the KDC 12 are included in a realm 104, and the terminal 13 and the KDC 14 are included in a realm 105. The terminal 15 and the KDC 16 are included in a realm 106.

The terminal 11 is mutually connected to the KDC 12, the terminal 13, the KDC 14, the terminal 15, and the KDC 16 via a network or the like.

Hereinafter, the operation of the embodiment shown in FIG. 3 will be described. The operation of the embodiment shown in FIG. 3 is approximately similar to that of the embodiment of FIG. 1. In the embodiment shown in FIG. 3, in the case where terminals belonging to plural different realms are to be accessed, however, IP addresses of KDCs in access destination realms are selected and embedded in the encryption portion of the TGT reply message.

Specifically, in the case where the terminal 11 is to access the terminal 13, the TGS of the KDC 12 selects the IP address of the KDC 14, embeds the selected IP address in an encryption portion of a TGT reply message to a TGT request for accessing the KDC 14, and then transmits the message to the terminal 11. By contrast, in the case where the terminal 11 is to access the terminal 15, the TGS of the KDC 12. selects the IP address of the KDC 16, embeds the selected IP address in an encryption portion of a TGT reply message to a TGT request for accessing the KDC 16, and then transmits the message to the terminal 11.

As a result, in the case where the terminal 11 is to access the terminal 13, the TGS of the KDC 12 selects the IP address of the KDC 14, embeds the selected IP address in the encryption portion of the TGT reply message to the TGT request for accessing the KDC 14, and then transmits the message to the terminal 11. In the case where the terminal 11 is to access the terminal 15, the TGS of the KDC 12 selects the IP address of the KDC 16, embeds the selected IP address in the encryption portion of the TGT reply message to the TGT request for accessing the KDC 16, and then transmits the message to the terminal 11. Therefore, the terminal 11 can safely obtain the IP address of the KDC 14 or 16. Consequently, mutual authentication that is high in security is enabled between different realms without previously setting the IP address of the KDC 14 or 16 to the terminal 11.

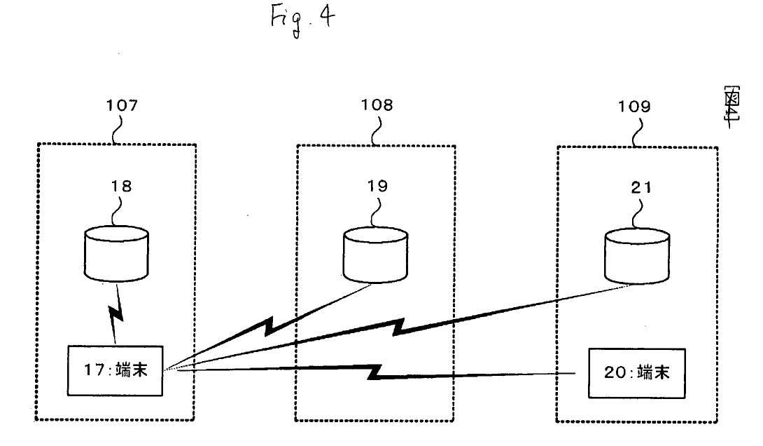

FIG. 4 is a configuration block diagram showing another embodiment of the authentication method of the invention and an authentication system which uses this.

In FIG. 4, the reference numeral 17 denotes a terminal which is to perform mutual authentication with another terminal, the reference numerals 18, 19, and 21 denote KDCs, and the reference numeral 20 denotes a terminal which is an object of the mutual authentication of the terminal 17. The terminal 17 and the KDC 18 are included in a realm 107, and the terminal 20 and the KDC 21 are included in a realm 109. The KDC 19 is included in a realm 108.

The terminal 17 is mutually connected to the KDC 18, the KDC 19, the terminal 20, and the KDC 21 via a network or the like.

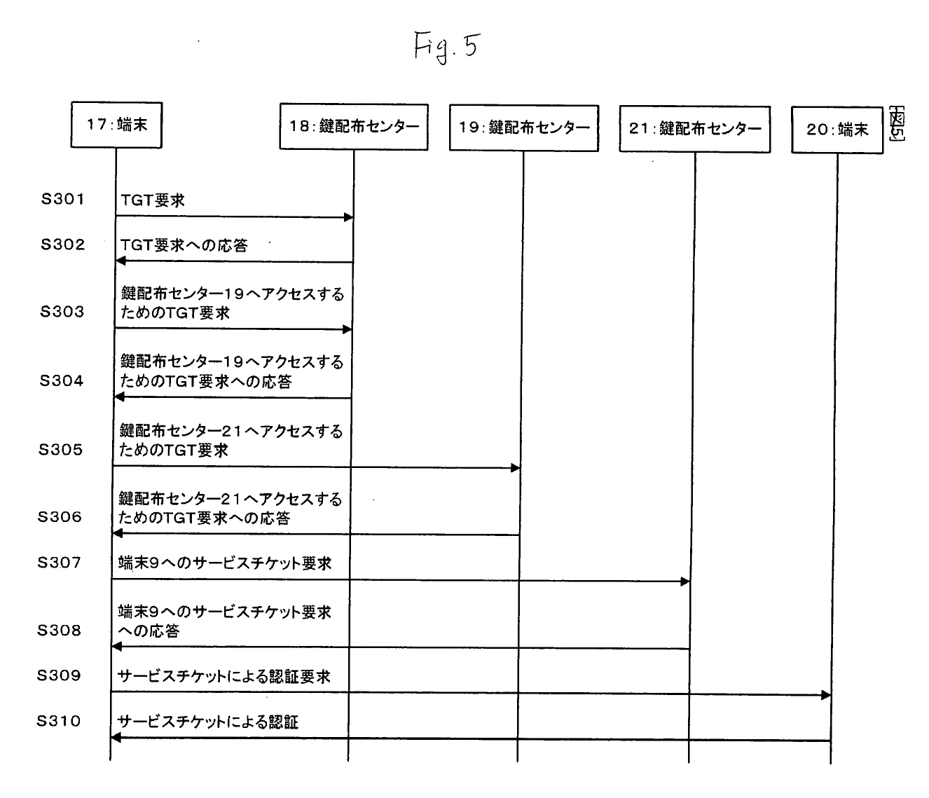

Hereinafter, the operation of the embodiment shown in FIG. 4 will be described with reference to FIG. 5. FIG. 5 is a message flowchart illustrating an operation in the case where an authentication service between different realms is provided.

The operation of the embodiment shown in FIG. 4 is approximately similar to that of the embodiment of FIG. 1. In the embodiment shown in FIG. 4, in the case where a terminals belonging to a first realm is to access to that belonging to a third realm, however, a TGT reply message in which an IP address of a KDC in a second realm is embedded in an encryption portion is obtained from a TGS of a KDC in the first realm, the IP address of the KDC in the second realm is extracted, and a TGT reply message in which an IP address of a KDC in the third realm is embedded in an encryption portion is obtained from the TGS of the KDC in the second realm.

In this case, the terminal belonging to the first realm, or the KDC in the first realm previously recognizes that the KDC in the second realm knows the IP address of the KDC in the third realm.

In “S301” in FIG. 5, the terminal 17 requests a TGT from the AS of the KDC 18. In “S302” in FIG. 5, the AS of the KDC 18 replies to the TGT request, and transmits a TGT reply message to the terminal 17.

In “S303” in FIG. 5, the terminal 17 requests a TGT for accessing the KDC 19 in the realm 108 from the TGS of the KDC 18. In “S304” in FIG. 5, in response to the TGT request, the TGS of the KDC 18 transmits a TGT reply message in which the IP address of the KDC 19 is embedded in an encryption portion, to the terminal 17.

In “S305” in FIG. 5, the terminal 17 extracts and decrypts the encrypted IP address of the KDC 19 from the TGT reply message obtained in “S304” in FIG. 5, and requests a TGT for accessing the KDC 21 in the realm 109, from the TGS of the KDC 19. In “S306” in FIG. 5, in response to the TGT request, the TGS of the KDC 19 transmits a TGT reply message in which the IP address of the KDC 21 is embedded in an encryption portion, to the terminal 17.

In “S307” in FIG. 5, then, the terminal 17 extracts and decrypts the encrypted IP address of the KDC 21 from the obtained TGT reply message obtained in “S306” in FIG. 5, and transmits the TGT to the TGS of the KDC 21 to request a service ticket which is a certificate for certifying that the terminal 17 is authenticated by the KDC 21. In “S308” in FIG. 5, in response to the request for a service ticket, the TGS of the KDC 21 transmits the service ticket to the terminal 17.

In “S309” in FIG. 5, the terminal 17 transmits the service ticket obtained in “S308” in FIG. 5 to the terminal 20 to request authentication. In “S310” in FIG. 5, finally, the terminal 20 which checks the service ticket in “S310” in FIG. 5 authenticates the terminal 17.

As a result, the terminal 17 obtains the TGT reply message in which the IP address of the KDC 19 in the realm 108 is embedded in the encryption portion, from the TGS of the KDC 18, and extracts and decrypts the encrypted IP address of the KDC 19, and the terminal 17 obtains the TGT reply message in which the IP address of the KDC 21 in the realm 109 is embedded in the encryption portion, from the TGS of the KDC 19, and extracts and decrypts the encrypted IP address of the KDC 21, whereby the terminal 17 is enabled to safely obtain the IP addresses of the KDCs 19 and 21.

Furthermore, the terminal 17 obtains a service ticket to the terminal 20 from the TGS of the KDC 21 with using the TGT obtained from the TGS of the KDC 19, authentication is requested to the terminal 20 with using the service ticket, and the terminal 17 is authenticated by the terminal 20, whereby mutual authentication that is high in security is enabled between different realms without previously setting the IP addresses of the KDCs 19 and 21 to the terminal 17.

In the embodiments shown in FIGS. 1, 3, and 4, an IP address of a KDC in a different realm is embedded in an encryption portion of a reply message, and then transmitted to a terminal. However, it is not always necessary to employ the embedding in an encryption portion of a reply message. Alternatively, an IP address of a KDC in a different realm may be encrypted by other means, and the encrypted IP address may be transmitted together with a TGT to a terminal.

In the embodiment shown in FIG. 3, as a realm which is an access object, only two realms or the realms 105 and 106 are described. It is not always necessary to dispose two realms. Plural realms which function as an access object can be disposed.

In the embodiment shown in FIG. 4, as a realm having the KDC 19 which transmits a TGT, only one realm or the realm 108 is described. It is not always necessary to dispose one realm, and one or more realms can be disposed.

The present application is based on Japanese Patent Application (No. 2006-138578) filed May 18, 2006, and its disclosure is incorporated herein by reference.

1. An authentication method in which authentication is performed between terminals respectively belonging to a first realm and a second realm that is different from said first realm, with using a Kerberos authentication method, wherein
in order to obtain authentication with the terminal belonging to said second realm, the terminal belonging to said first realm requests a ticket granting ticket for accessing a key distribution center in said second realm, from a key distribution center in said first realm,
said key distribution center in said first realm transmits an encrypted IP address of said key distribution center in said second realm together with the requested ticket granting ticket, to said terminal belonging to said first realm,
based on the IP address, said terminal belonging to said first realm accesses said key distribution center in said second realm, to receive provision of a service ticket, and
said terminal belonging to said second realm authenticates said terminal belonging to said first realm with using the service ticket.

2. An authentication system in which authentication is performed between terminals respectively belonging to a first realm and a second realm that is different from said first realm, with using a Kerberos authentication method, said system comprising:
the terminal which belongs to said first realm, and which, in order to obtain authentication with the terminal belonging to said second realm, requests a ticket granting ticket for accessing a key distribution center-in said second realm;
a key distribution center which is in said first realm, and which transmits an encrypted IP address of said key distribution center in said second realm together with the requested ticket granting ticket, to said terminal belonging to said first realm;
said key distribution center which is in said second realm, and which provides a service ticket based on the ticket granting ticket obtained by said terminal belonging to said first realm; and
said terminal which belongs to said second realm, and which authenticates said terminal belonging to said first realm with using the service ticket.

3. An authentication system in which authentication is performed between terminals respectively belonging to different realms, with using a Kerberos authentication method, said system comprising:
a terminal which belongs to a first realm, and which, in order to obtain authentication with an arbitrary one of plural terminals respectively belonging to plural different realms, requests a ticket granting ticket for accessing a key distribution center in a second realm to which said arbitrary terminal belongs;
a key distribution center which is in said first realm, which selects an IP address of said key distribution center in said second realm to which said arbitrary terminal belongs, from IP addresses of plural key distribution centers respectively in said plural different realms, and which transmits the selected encrypted IP address of said key distribution center in said second realm together with the requested ticket granting ticket, to said terminal belonging to said first realm;
said key distribution center which is in said second realm, and which provides a service ticket based on the ticket granting ticket obtained by said terminal belonging to said first realm; and
said arbitrary terminal which authenticates said terminal belonging to said first realm with using the service ticket.

4. An authentication system in which authentication is performed between terminals respectively belonging to different realms, with using a Kerberos authentication method, said system comprising:
a first terminal which belongs to a first realm, and which, in order to obtain authentication with a second terminal belonging to a third realm, requests a ticket granting ticket for accessing a key distribution center in said third realm, from a first key distribution center in said first realm or a second key distribution center in a second realm;
said first key distribution center which transmits an encrypted IP address of said second key distribution center together with the requested ticket granting ticket, to said first terminal;
said second key distribution center which transmits an encrypted IP address of said third key distribution center together with the requested ticket granting ticket, to said first terminal;
said third key distribution center which provides a service ticket based on the ticket granting ticket that is obtained by said first terminal from said second key distribution center; and
said second terminal which authenticates said first terminal with using the service ticket.
